(19) United States
(12) Patent Application Publication
(10) Pub. No.: US 2013/0144761 A1
(43) Pub. Date: Jun. 6, 2013

(54) System and method for the distribution of digital content and revenue

(71) Applicant: Josh Unger, Brooklyn, NY (US)

(72) Inventor: Josh Unger, Brooklyn, NY (US)

(21) Appl. No.: 13/685,843

(22) Filed: Nov. 27, 2012

Related U.S. Application Data
(60) Provisional application No. 61/565,959, filed on Dec. 1, 2011.

(51) Int. Cl. G06Q 30/06

(52) U.S. Cl. CPC G06Q 30/0633
USPC 705/26.81

(57) ABSTRACT

System and method for rewarding the creators, owners, and distributors of digital media are enclosed. The system enables creators and owners to sell digital media to consumers via the Internet. When a consumer purchases the media, the creator or owner is rewarded. The system also enables each consumer who purchases the media to become a distributor, providing tools to promote and sell copies of that media to subsequent purchasers. A subsequent sale rewards both the distributor and the creator or owner. Further sales continue to reward the creator or owner and all or some of the previous distributors along the chain of distribution. The creator or owner sets the sales price, and the rewards are a percentage of the sales price. The creators', owners', and distributors' rewards are determined by their proximity to the most recent sale.

### BACKGROUND

Through advances in Internet technology, there are now numerous ways for creators to distribute digital content to consumers. These advances have brought great changes to the traditional distribution industries, which were formed in an era when distribution mostly concerned the sale of physical media. Along with the advances, new challenges have emerged in the effort to more efficiently and expansively distribute content to consumers. Specifically, the challenges include developing systems to help consumers discover content that is meaningful to them, to better reward the creators of content, and to minimize exposure to digital piracy.

The two main ways to disseminate content to consumers are to provide access to hosted content that remains on a remote server or to permit the consumer to download the content in a portable file format. Examples of hosted content include a news article on a web page or a streamed song or video. In contrast, a download provides the consumer with actual possession of a complete copy of the digital content, in a format that he can copy, move, store, or pass on to another consumer.

For the hosting of audio and video data, it is stored remotely on a provider's server and various technologies enable a client-server connection in which a software client running on the consumer's playback device receives a “stream” of data at the time of playback. In most cases, playback commences before the entirety of the data has been transferred. Streaming data effectively passes through the consumer's device. It is not permanently retained there, which provides a distinct advantage in giving the consumer access to larger libraries of content than what they could own outright, either because of the cost of the content or because of limits on their personal storage capacity. Additionally, streaming provides the consumer with the convenience of accessing data through a variety of devices. Since the content is stored remotely, and accessed through an Internet connection, it does not matter which device the consumer is using, allowing him the freedom to use a phone, an mp3 player, or a computer. With streaming, these devices are easily exchanged, thus preventing a consumer from becoming tied to an obsolete piece of technology.

While streaming presents some advantages to the consumer, it also has a variety of problems. The primary shortcoming of streaming is the constant necessity of an Internet connection. If a consumer is relying on a mobile device, he may not be able to access the content in certain situations, such as being underground, in a brick building, or a rural environment. Any problem with mobile Internet access becomes a factor, including peak signal demands, power failures, faulty devices, etc. Additionally, streaming also puts limits on audio quality, as it typically entails some degree of compression to conserve bandwidth. This seems to be an acceptable compromise for non-audiophile listeners.

One more disadvantage to streaming is the consumer's lack of ownership. There is no actual copy in the possession of the consumer, which inhibits his ability to utilize the content in a personalized way, and distances him from forming an intimate relationship with the content. The collector's urge remains a strong driver of consumer behavior, particularly for products that are emblematic of the consumer's taste and self-identification.

Downloading entails the acquisition by the consumer of a media file. Once downloaded, the file resides locally on the consumer's drive, device, or other storage media. Advantages of downloading include the ability to move the file between devices and access the content without an Internet connection. Additionally, downloading gives the consumer a sense of ownership. A download leaves the consumer in lasting possession of the content, regardless of the fortunes of the outlet from which the file was acquired.

There are some problems with downloading for the consumer, however. He incurs the nominal cost and risk of data storage, and the inconvenience of having to copy downloaded files to playback devices. If a downloaded music file is lost, the consumer typically has no lasting claim on ownership.

While ownership of files provides the consumer with the advantage of unfettered abilities to move, copy, and transfer, it also creates a problem for the content provider in the form of increased likelihood of piracy. At virtually no cost, anyone with a computer can replicate a digital file. Illicit copies proliferate throughout the connected world via an array of channels, and the volume of illicit exchange increases in proportion to the growing availability of broadband Internet.

Piracy is a major problem with downloading, and content creators have been developing ways to combat piracy, including digital rights management (DRM). DRM is the embedding of restrictions in files intended to thwart illicit exchange. It is designed to prevent files from being accessed outside of particular parameters, an example being a single device. Because of these restrictions, DRM is extremely unpopular with consumers.

Social networks have increased dramatically in recent years, and the way people discover content has changed in turn. Previously, consumers became aware of content by connecting with the source, the creator or publisher. It might be described as a hub and spoke model. The Internet has increased the ability for this type of interaction, but has also evolved into a social network model, where consumers' connections with other consumers provide more avenues for content discovery. People are sharing among each other and thus finding content more in tune with their preferences, or the preferences of their social groups.

This marketing, between people with personal connections, is an efficient means for consumers to discover desired content, but is not perfect. The current reward system for sharing is lacking. The incentive to share is nothing more than a social reward. When a person shares content with others who like it, or purchase it, that person's social status may rise through the function of making others happy or by increasing the number of connections. This system does not provide for monetary rewards for sharing information about new and exciting content.

There is yet to be a way to provide consumers with lasting access to content, while properly rewarding and protecting the intellectual property of the creator. Content creators and owners face a challenge: how to prosper from products that can be replicated and distributed in an instant, for free, and heedless of conventional notions of ownership. For the foregoing reasons, there is a need for a method of distributing digital content, which allows users to own a downloaded copy, rewards people for availing the content to others, and creates incentives for the consumer to avoid piracy.

### SUMMARY

The present invention is a method to distribute digital content and financially reward the owners and distributors of the content, and a system of computers on which to implement the method.

The method for distributing digital content is facilitated through the Internet, one means being an Internet website. The website has user accounts, which require content owners and consumers to provide identifying information to facilitate the transactions and provide online identifiers for social networking purposes.

The owner of the content begins the distribution process by offering it for sale on the website. Content owners are those that have the rights to sell or license the content. Information about the content is available to the general public, but a person must create a user account to preview, purchase, and download the content. A system of previewing will allow a user to sample the content in order to make a decision on whether to buy.

Once a purchaser buys the content, he can download a copy of the content to any device. The consumer now owns a copy and the right to download as many copies from the web site as desired. Additionally, the consumer may also promote and facilitate sales of the same content through an interface provided by the system. Any future purchase of the content can be made from the original owner's page or the page of any consumer who has purchased the content. This structure creates a chain of distributors, where each person in the chain, from the owner to the most recent purchaser, has the ability to sell the content. A seller, or a sale, of content refers to any person who is an owner of the content selling it to a consumer, or to any purchaser (not the owner) who is acting as an agent in the sale of the content from the owner to another subsequent purchaser.

Purchasers have the ability to recommend the content they have purchased to others. Recommendations can be made to anyone in the general public or through a social network of connections on the web site. There is an incentive for people to recommend and attempt to generate sales of the content to others, as each sale rewards the person who made the recommendation and sold the content.

When a buyer purchases from a content owner directly, all net proceeds go to the owner. However, when one or more intermediary purchasers separate the current buyer and the owner, the net proceeds are divided between the owner and the intermediaries.

The exact percentages in such a transaction are predetermined by the system prior to the sale. This method of distributing the net proceeds continues from the current seller back through previous purchasers to the owner. The current seller collects a predetermined percentage and the seller that sold him the content collects a predetermined percentage based on his proximity to the current sale. The percentage of net proceeds that each seller in the chain collects is dictated by his proximity to the current sale.

This system of selling is designed to incentivize the most recent sale. Creating incentives for the most recent seller will stimulate distribution of the content, by rewarding users who spread awareness of the content and execute sales. This is accomplished by rewarding the current seller of content with a higher percentage of revenue from a particular sale than the previous seller will receive. The percentage of sales revenue diminishes going back through the chain of distribution, upstream towards the owner. The owner's share of revenue is set so that he receives at least his preset minimum for any sale of his content by any user, and his maximum revenue is one hundred percent of any sale he makes directly, minus transaction costs. Transaction costs are the costs associated with building, maintaining, and operating the system.

A purchaser in the system has no increased monetary incentive to purchase directly from the owner or any particular seller. The price of the content is the same regardless of whom it is purchased from. However, a purchaser may feel an incentive to purchase from certain people he wishes to reward, either because he has a friendly relationship with that seller or owner, or because he wishes to form a stronger link to that seller or owner and gain greater access to that person's digital content catalog. It is a person's access to content, and ability to sell that content, that is rewarded by the system, and what makes it a better way to distribute content.

The revenue distribution is variable depending on presets in the system, within certain parameters. The owner sets the sales price of the content, and receives a minimum percentage from any sale. The system dictates the percentage each seller earns from a sale of the content depending on where that seller is in the chain of distribution, whether the seller is the current seller of the content, or somewhere up the chain. This revenue distribution could take on a number of forms, but must adhere to one principle; the current seller's share of revenue must be greater than that of the previous sellers in that particular chain of distribution. This principle holds for all sellers along the chain of distribution, with the exception of the owner, whose base percentage of revenue is fixed. Each seller's share of revenue must be greater than the previous seller's share based on his proximity to the closest sale.

This method is advantageous because it rewards the purchase and distribution of content. A user has an incentive to purchase content, because he will now have the ability to share in and promote the popularity of the content. When a consumer also has the ability to profit from that content's popularity, and successive sales, the consumer has an additional incentive to purchase the content, in belief that others beside himself will enjoy and choose to purchase the content.

This incentive to purchase the content is also an incentive not to pirate content. If a person gains access to the content through illegal means, he will not legally have the ability to profit from resale of the content. If a person purchases the content through this method and system, he will legally have the ability to profit from future sales through his chain of distribution, in direct sales to other consumers, and in any of those consumers' subsequent sales as well. The ability to potentially profit, and mitigate the costs of owning digital content, will incentivize pirates and law-abiding consumers to obtain content through the method and system, instead of through other current digital content purchasing platforms or through illegal means.

### BRIEF DESCRIPTION OF THE DRAWINGS

FIG. 1 illustrates an exemplary computer system according to the present invention.

FIG. 2 illustrates a flow chart of the uploading of digital content in accordance with one embodiment in the present invention.

FIG. 3 illustrates a flow chart of the primary purchase of digital content in accordance with one embodiment in the present invention.

FIG. 4 illustrates a flow chart of the secondary purchase of digital content in accordance with one embodiment in the present invention.

FIG. 5 illustrates a tree diagram showing the relationship between purchasers of digital content in accordance with one embodiment in the present invention.

FIG. 6 illustrates a flow chart of the revenue distribution in accordance with one embodiment of the present invention.

### DETAILED DESCRIPTION AND BEST MODE

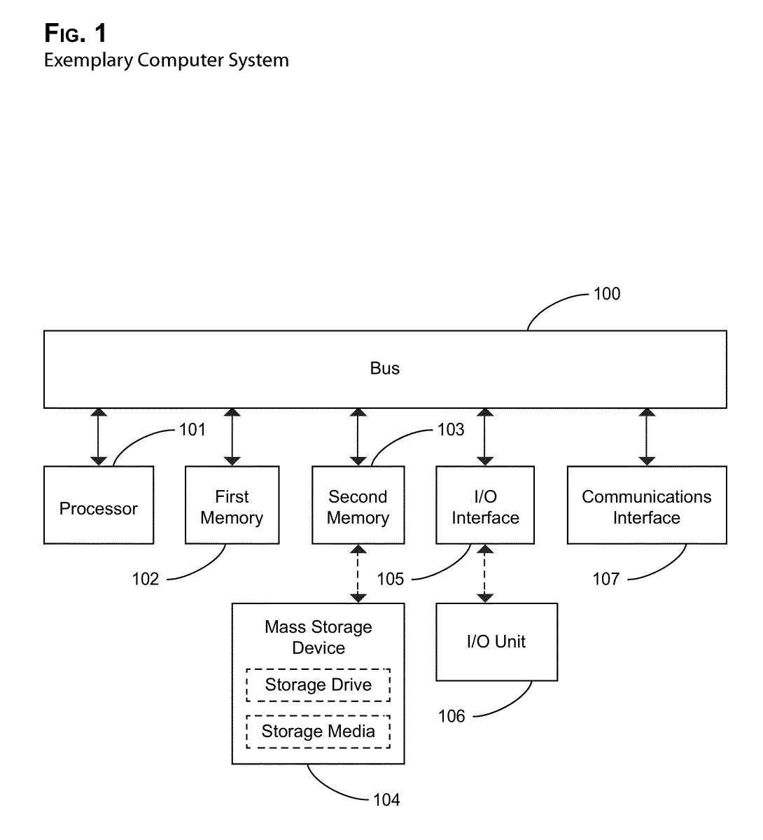

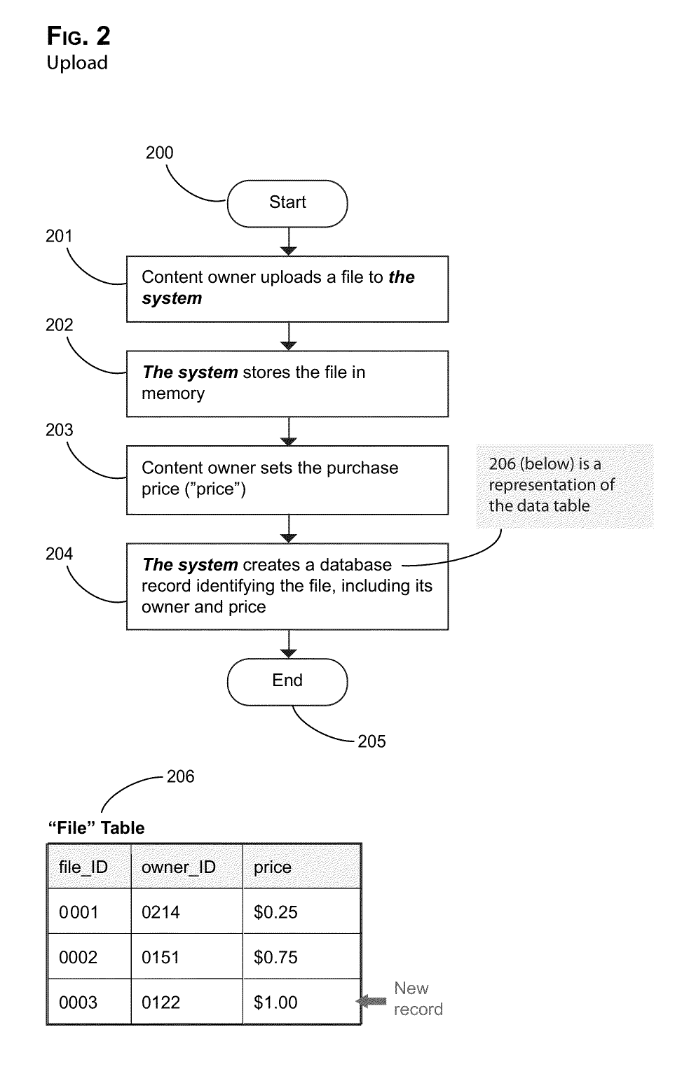

FIG. 1 illustrates an example of a computer system, or network, that may be used to implement the methods of the present invention. One or more computer systems may carry out the methods described herein as computer code. At least one processor 101 is connected to a bus 100. As shown in FIG. 1, the bus connects the processor to various other components of the computer system, but the bus may also connect the processor to additional components not shown. It is contemplated that the bus connects the processor to other computer systems. The processor can receive computer code through the bus. The term “computer code” includes, for example, programs, instructions, signals and/or data. The processor executes the computer code and may also send computer code through the bus.

The computer system may include one or more memories, such as first memory 102 and second memory 103. The first memory, secondary memory, or a combination thereof may function as a storage medium to store and/or access computer code. The first memory and second memory may be, for example, random access memory (RAM), read-only memory (ROM), a mass storage device, or any combination thereof.

As shown in FIG. 1, one embodiment of second memory is a mass storage device 104, although the first memory may be the mass storage device. The mass storage device comprises a storage drive and a storage media. The storage media may be removable from the storage drive. Mass storage devices with storage media that are removable allow computer code to be transferred to and from the computer system.

A mass storage device may include, for example, a Compact Disc Read-Only Memory (“CDROM”), ZIP storage device, tape storage device, magnetic storage device, optical storage device, Micro-Electro-Mechanical Systems (“MEMS”), nanotechnological storage device, floppy storage device, or hard disk device. The mass storage device also includes program cartridges and cartridge interfaces (such as that found in video game devices), removable memory chips (such as an EPROM, or PROM) and associated sockets.

The computer system may include other means for computer code to be loaded into or removed from the computer system, for example, input/output (“I/O”) interface 105 and/or communications interface 107. Both the I/O interface and the communications interface allow computer code to be transferred between the computer system and external devices including other computer systems.

Computer code transferred by the I/O interface and the communications interface are typically in the form of signals, which may be electronic, electromagnetic, optical, or other signals capable of being sent and/or received by the interfaces. These signals may be transmitted via a variety of modes including, but not limited to, wire or cable, fiber optics, a phone line, a cellular phone link, infrared (“IR”), and radio frequency (“RF”) link.

The I/O interface may be any connection, wired or wireless, that allows the transfer of computer code. An I/O interface includes, for example, an analog or digital audio connection, digital video interface (“DVI”), video graphics adapter (“VGA”), musical instrument digital interface (“MIDI”), parallel connection, PS/2 connection, serial connection, universal serial bus connection (“USB”), IEEE1394 connection, PCMCIA slot and card. In certain embodiments the I/O interface connects to an I/O unit such as a user interface, monitor, speaker, printer, or touch screen display 106.

The invention is also directed to computer products to provide software that includes computer code to the computer system. The processor executes the computer code in order to implement the methods of the present invention. As an example, the methods according to the present invention may be implemented using software that includes the computer code, wherein the software is loaded into the computer system using a memory, such as the mass storage drive, or through an I/O interface, communications interface, or any other interface with the computer system. The computer code in conjunction with the computer system described herein may perform any one of, or any combination of, the steps of any of the methods presented herein. It is also contemplated that the methods according to the present invention may be performed automatically, or may be invoked by some form of manual intervention.

The computer system, or network architecture, of FIG. 1 is provided only for purposes of illustration, such that the present invention is not limited to this specific embodiment. It is appreciated that a person skilled in the relevant art knows how to program and implement the invention using any computer system or network.

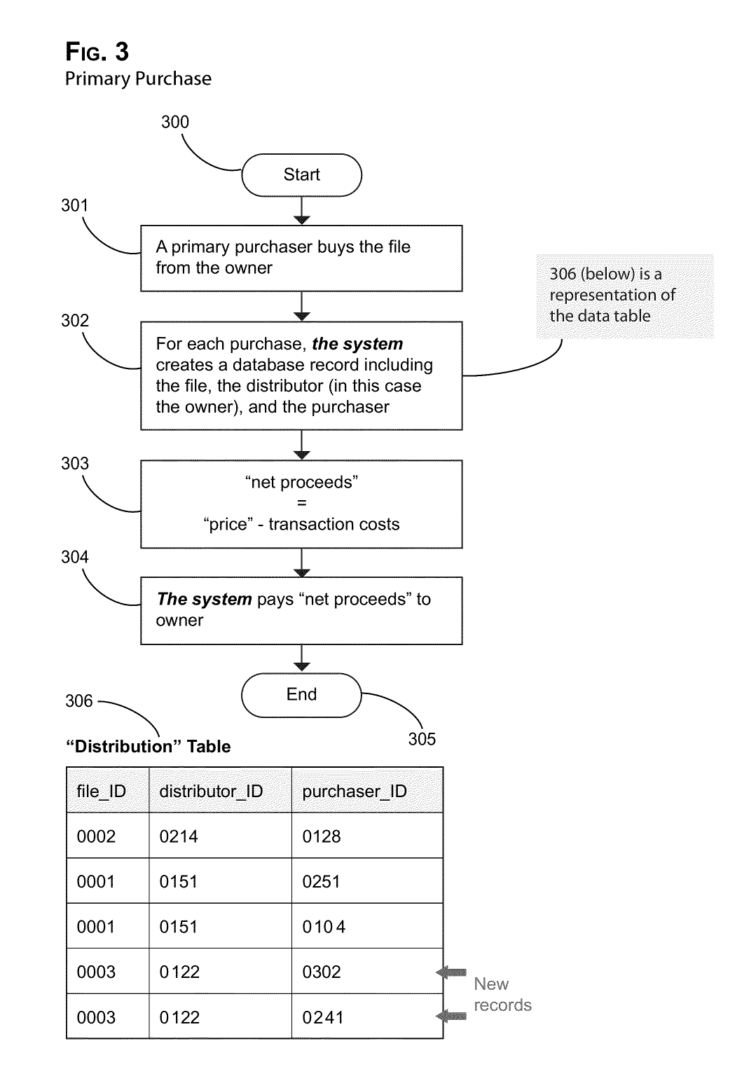

FIG. 2 illustrates a flow chart of the uploading of digital content in accordance with one embodiment in the present invention. In this embodiment a content owner selects digital content to upload to the system 201. The digital content could be a file of any type, including but not limited to audio, video, text, or multimedia. The best mode is anticipated to be audio files, specifically music. Once the digital content is uploaded, it is stored in the memory 202 as a database record 204 along with certain identifying characteristics 206, a file ID to distinguish the file from others, an owner ID, a pointer to the location of the file, and a price 203 at which the file will be sold. In this embodiment, the owner sets the price prior to the first sale. In alternative embodiments, the owner may elect to change the price at a later time. The owner may decide a greater or lesser price will be more profitable based on sales metrics.

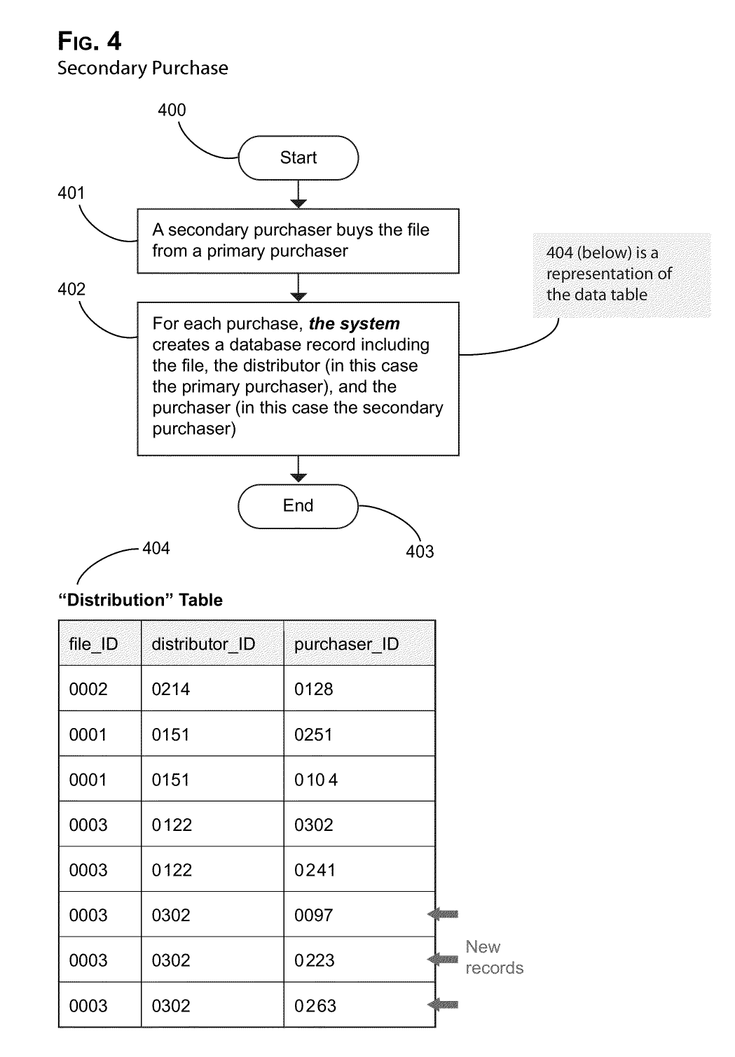

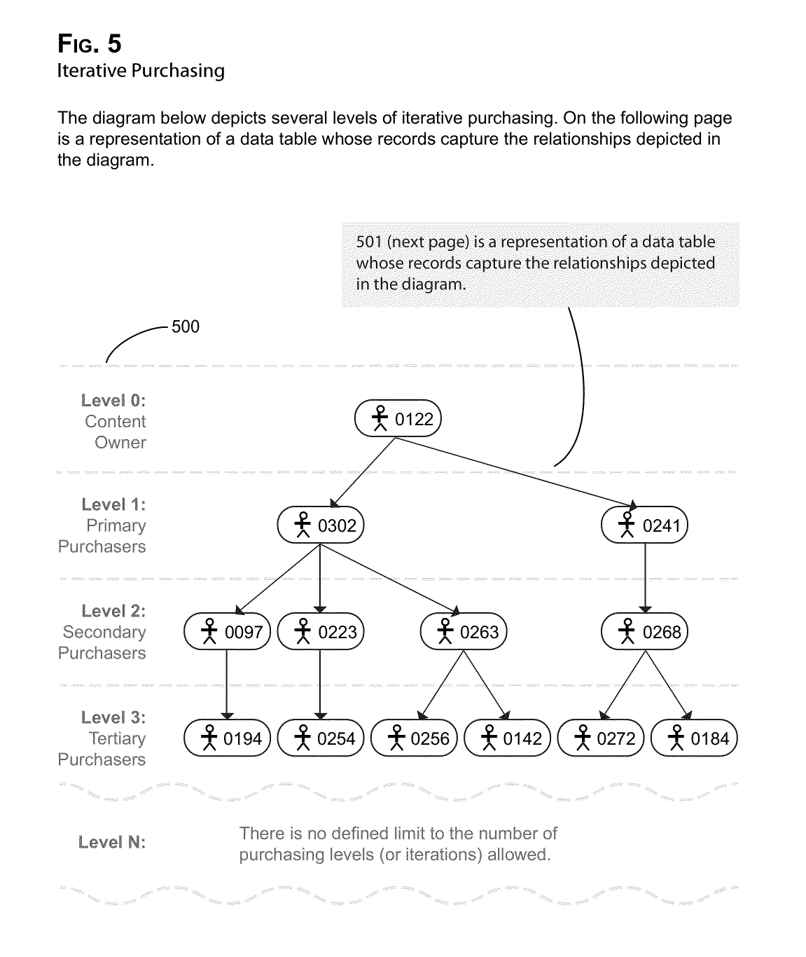

FIG. 3 illustrates a flow chart of the primary purchase of digital content in accordance with one embodiment in the present invention. In this embodiment, the first sale of the content is from the owner to a primary purchaser 301. The system creates a database record for each purchase, including the file ID, the distributor, and the purchaser 302. In this embodiment, the distributor is the owner, and the purchaser is the primary purchaser. The net proceeds are the purchase price, set by the owner minus any transaction costs 303. The net proceeds are given to the owner 304. The best mode envisioned entails the transaction costs taken out of each transaction. Alternative embodiments may have transaction costs deducted at another time, possibly at the opening of a user account, the uploading of content, or the withdrawal of funds from an account.

The owner may distribute the file to any number of primary purchasers, and the system will record each transaction in a database 306. In this case, a copy of the digital file will be sent to each primary purchaser. The best mode of this transaction will be the primary purchasers downloading a copy of the file. Alternative embodiments could have the purchasers merely obtaining the right to download, and the file will be stored at central location, where it can be downloaded at another time, or streamed in the case of audio or video files.

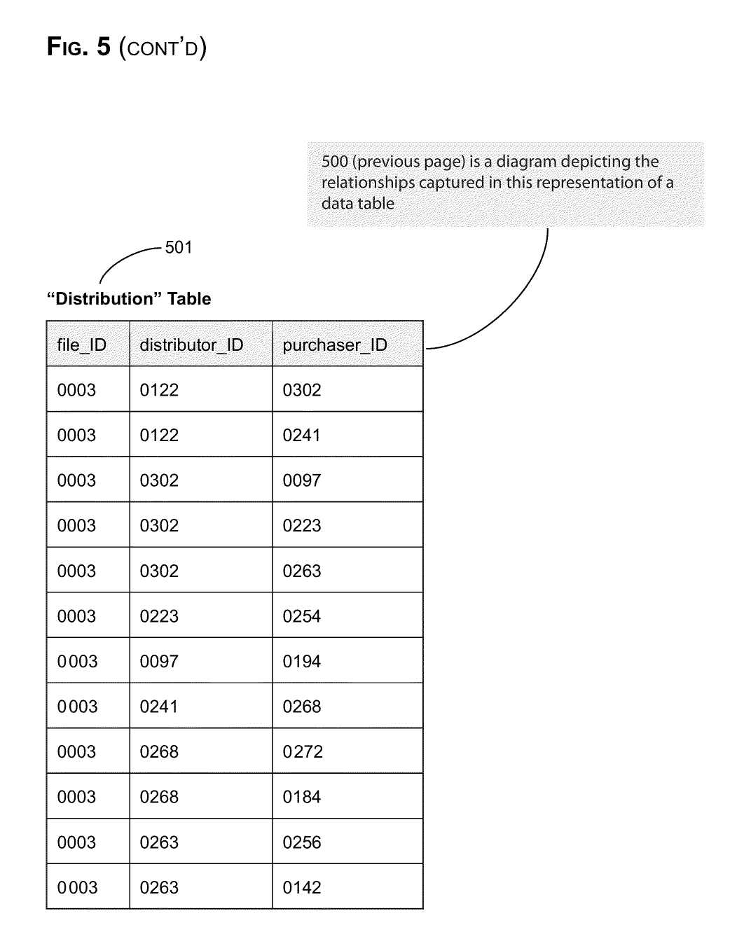

FIG. 4 illustrates a flow chart of the secondary purchase of digital content in accordance with one embodiment in the present invention. At least one primary purchaser sells the digital content to a secondary purchaser 401. Like the primary purchase, a record of this transaction is kept, as shown in the distribution table 402. Each piece of digital content can be replicated for each transaction, and each primary purchaser may sell the digital content file to as many secondary purchasers as desired. Likewise, each secondary purchaser may sell the content to tertiary purchasers, and so on. It is important to keep a record of each file's path from the owner to each recipient, as this data will help determine the distribution of revenue for each transaction 404.

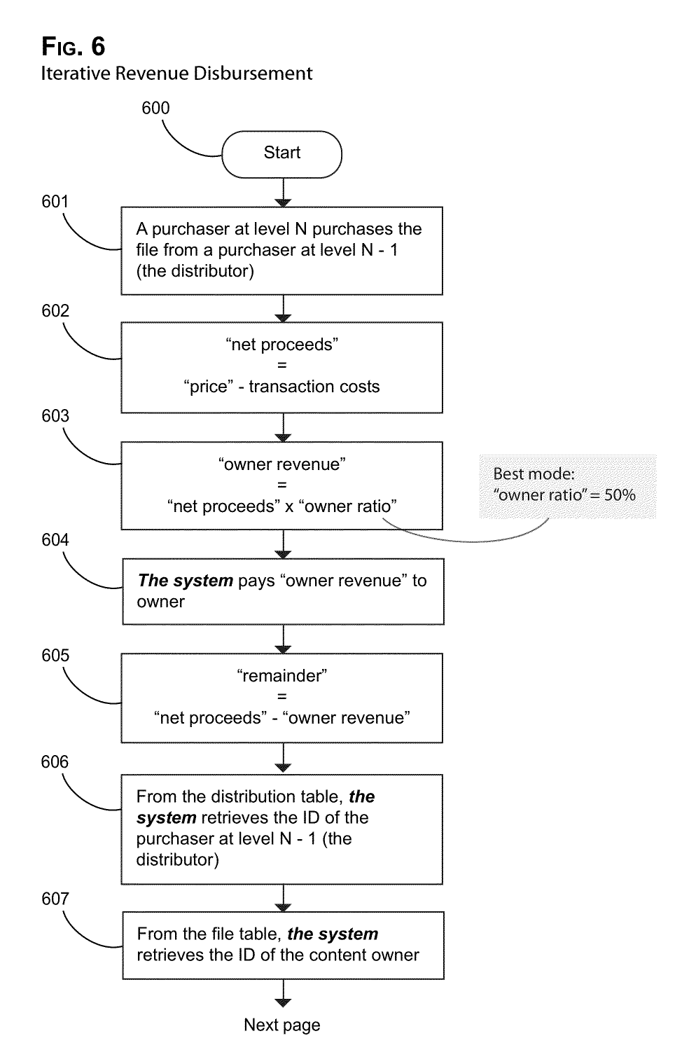

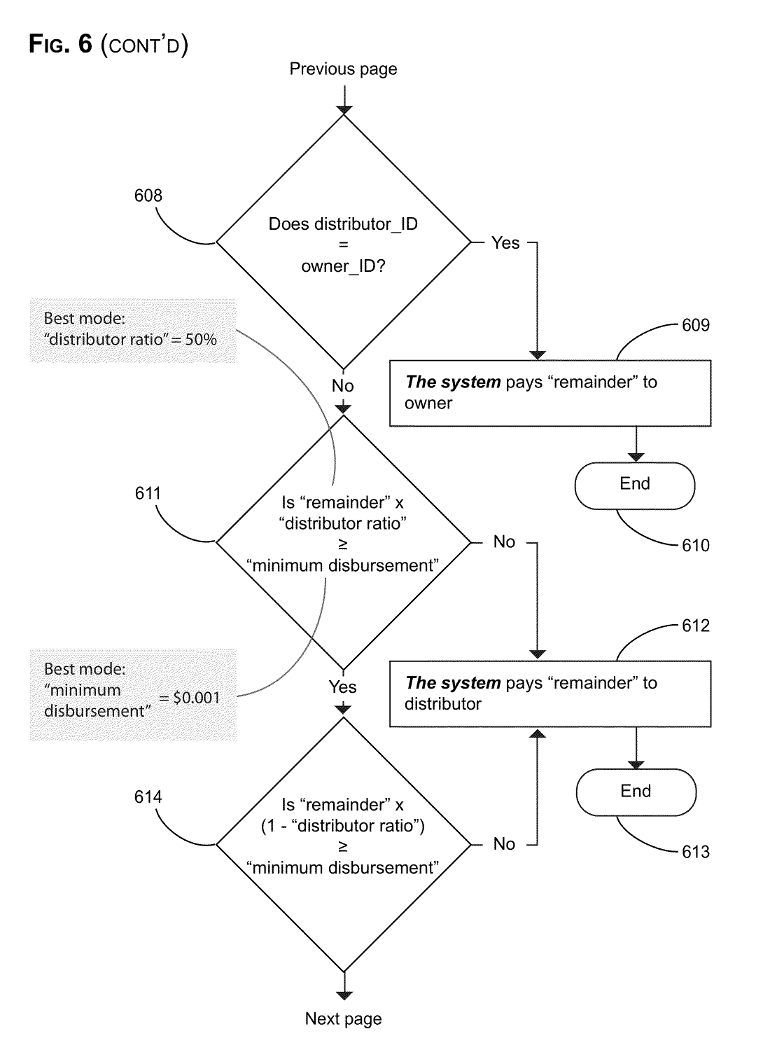

FIG. 5 illustrates a diagram of the distribution of digital content in accordance with one embodiment in the present invention. The identification numbers for each person in the diagram are merely for demonstration purposes. In this diagram, the owner 0122 sold copies of the same digital content to two primary purchasers, 0302 and 0241. Primary purchaser 0302 sold a copy of the same content to three secondary purchasers, 0097, 0223, and 0263. Primary purchaser 0241 sold the content to another secondary purchaser 0268. Each of the secondary purchasers has sold copies of the content on to tertiary purchasers. These tertiary purchasers may now sell copies of the content to quaternary purchasers, and so on. The diagram 500 shows the path of the content on its journey from the owner to the tertiary purchaser 0256. The content was sold to 0256 from 0263, and he bought the content from 0302, who bought the content from the owner 0122. In this embodiment, the revenue from a sale of the content to 0256 will be distributed back through the chain. Recipient 0263, 0302 and owner 0122 will all receive a share of the net proceeds.

All transactions involving the sale of digital content will be stored in a database, showing the file, the distributor and the purchaser 501.

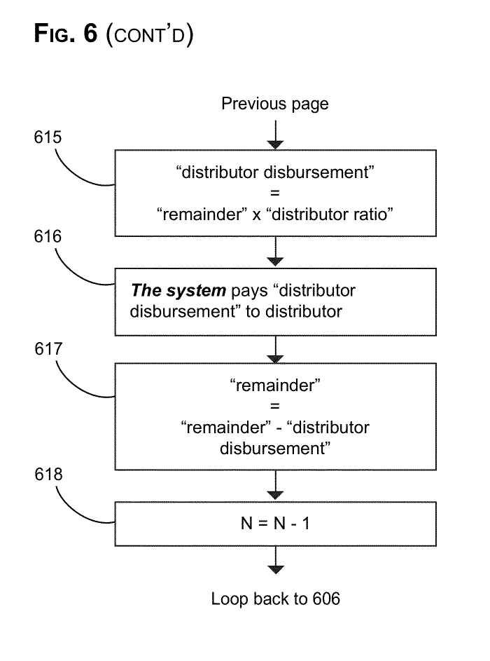

FIG. 6 illustrates a flow chart of the revenue distribution in accordance with one embodiment of the present invention. This chart demonstrates the logic behind the calculation of revenue delivered to purchasers in the chain of distribution for a given sale of content. As in FIG. 5, one embodiment of a chain of distribution for the content went from the owner 0122, to the primary purchaser 0302, to the secondary purchaser 0263, to the tertiary purchaser 0256 500. For each sale after the primary purchase, the net proceeds are distributed to some or all of the previous purchasers in the chain of distribution and the owner. In the example of the sale to tertiary purchaser 0256, the flow chart demonstrates how the revenue will be distributed to 0263, 0302, and 0122 600.

The flow chart in FIG. 6 demonstrates how the revenue from every sales transaction in the system is calculated. These calculations are determined based on where the transaction is taking place in relation to the owner. A simple way of visualizing the transactions is to format them into a tree diagram. An example of such a diagram is shown in FIG. 5 500. The owner 0122 is shown at Level 0, and the primary purchasers are shown at Level 1. The level indicates the number of sales that have occurred prior to the users at that level obtaining the digital content. The secondary purchasers are at Level 2. The tertiary purchasers are at Level 3, and so on.

In calculating the distribution of revenue for a transaction, it is necessary to identify which level the current transaction is taking place on. The following example utilizes the chart in FIG. 6 to calculate the revenue distributions for three example transactions; the sale from the owner 0122 to the primary purchaser 0302, the sale from the primary purchaser 0302 to the secondary purchaser 0263, and the sale from the secondary purchaser to the tertiary purchaser 0256.

In this example, primary purchaser 0302, at Level 1, purchases the content from the owner 0122, at Level 0 601. The transaction costs are deducted from the price of the content, resulting in the net proceeds 602. The net proceeds are then multiplied by the owner ratio 603. In the best mode, the owner ratio is set at 0.5 (one half). This ratio may be set at any number between zero and one, or a function resulting in a number between zero and one, as market considerations dictate. The net proceeds multiplied by the owner ratio equal the owner revenue, and that amount is paid to the owner 604. The remainder is left after the owner revenue is subtracted from the net proceeds 605. The distribution table 501 and the file table 206 are referenced in order to determine who receives the remainder 606, by indentifying all the users in the chain of distribution and the owner of the digital content 607. The system then checks if the seller in the current transaction is the same as the owner of the digital content 608. In this transaction, the owner 0122 sold the content to the primary purchaser 0302. Since the owner is the seller in this transaction, the owner is paid the remainder as well as the owner revenue 609. In this transaction, and any transaction from the owner to any primary purchaser, the owner receives all of the net proceeds.

Following the chain of distribution in this embodiment, the primary purchaser 0302, at Level 1, then sells a copy of the content to secondary purchaser 0263, at Level 2, 601. In this transaction, the net proceeds of the sale are distributed to the secondary purchaser 0263, primary purchaser 0302, and the owner 0122. The net proceeds are calculated by subtracting the transaction costs from the price 602, and the owner revenue is calculated by multiplying the net proceeds by the owner ratio 603. The owner 0122 is paid the owner revenue from this transaction 604. The remainder is calculated by subtracting the owner revenue from the net proceeds 605. The distribution table 501 is referenced in order to determine the identity of the user who sold the digital content to the secondary purchaser 0263 606. In this example, that user is the primary purchaser 0302. The system then references the file table 206, and identifies the owner of the digital content, which in this case is the owner 0122 607. Since the primary purchaser 0302 is not the owner 0122 608, the system must make a determination if the remainder is large enough to economically justify dividing the remainder among previous sellers in the chain of distribution 611. This is done by multiplying the remainder by the distributor ratio. In the best mode, the distributor ratio is 0.5, but it may be any number between zero and one, or the result of any function creating a number between zero and one. This number is then compared to a minimum disbursement amount. The minimum disbursement amount is the minimum amount at which any revenue disbursement is made. In the best mode, the minimum disbursement amount is set at $0.001. This number represents the cost of the system performing a revenue disbursement transaction. If the product of the remainder and the distributor ratio is less than the minimum disbursement amount, the remainder is paid to the distributor, in this example primary purchaser 0302 612. If the product of the remainder and the distributor ratio is greater than the minimum disbursement amount, another calculation must be made in order to determine the distribution of the remainder of the net proceeds. The remainder is now multiplied by (1—distributor ratio) 614. If this product is less than the minimum disbursement amount, the system pays the remainder to the distributor, in this case primary purchaser 0302 612. If this product is greater than the minimum disbursement amount, the system then calculates the distributor disbursement amount for primary purchaser 0302, by multiplying the remainder by the distributor ratio 615. This distributor disbursement amount is paid to the primary purchaser 0302, and subtracted from the remainder 616. When the distributor disbursement amount is subtracted from the remainder, a new remainder is created 617. The distribution table 501 is referenced to determine the next previous distributor at Level N-1. In this situation, the next distributor of the digital content is the owner 0122 at Level 0 618, 606.

The system then determines how to distribute the new remainder through the same process described above. In this example, the system references the file table 206 to find the owner of the digital content, and determines that it is owner 0122 607. Since the distributor at this level, Level 0, is the same as the content owner 608, the remainder is paid to the content owner 609, and no further disbursements of the revenue from this transaction are necessary 610.

Following the chain of ownership in this embodiment, the secondary purchaser 0263, at Level 2, then sells a copy of the digital content to tertiary purchaser 0256, at Level 3, 601. In this transaction, the net proceeds of the sale are distributed to the tertiary purchaser 0256, secondary purchaser 0263, primary purchaser 0302, and the owner 0122. The net proceeds are calculated by subtracting the transaction costs from the price 602, and the owner revenue is calculated by multiplying the net proceeds by the owner ratio 603. The owner 0122 is paid the owner revenue from this transaction 604. The remainder is calculated by subtracting the owner revenue from the net proceeds 605. The distribution table 501 is referenced in order to determine the identity of the user who sold the digital content to the tertiary purchaser 0256 606. In this example, that user is the secondary purchaser 0263. The system then references the file table 206, and identifies the owner of the digital content, which in this case is the owner 0122 607. Since the secondary purchaser 0263 is not the owner 0122 608, the system must determine if the remainder is large enough to economically justify dividing the remainder between subsequent distributors in the chain of distribution 611. The remainder is multiplied by the distributor ratio (0.5), and then compared to the minimum disbursement amount, $0.001. If the product of the remainder and the distributor ratio is less than the minimum disbursement amount, the remainder is paid to the distributor, in this case the secondary purchaser 0263 612. If the product of the remainder and the distributor ratio is greater than the minimum disbursement amount, another calculation must be made in order to determine the distribution of the remainder of the net proceeds. The remainder is now multiplied by (1—distributor ratio) 614. If this product is less than the minimum disbursement, the system pays the remainder to the distributor, in this case secondary purchaser 0263 612. If this product is greater than the minimum disbursement amount, the system then calculates the distributor disbursement amount for secondary purchaser 0263, by multiplying the remainder by the distributor ratio 615. This distributor disbursement amount is paid to the secondary purchaser 0263, and subtracted from the remainder 616. When the distributor disbursement amount is subtracted from the remainder, a new remainder is created 617. The distribution table 501 is referenced to determine the next previous distributor at Level N-1. In this situation the next distributor of the digital content is the primary purchaser 0302 at Level 1 618, 606.

The system then references the file table 206, and identifies the owner of the digital content, which in this case is the owner 0122 607. Since the primary purchaser 0302 is not the owner 0122 608, the system must determine if the remainder is large enough to economically justify dividing the remainder between subsequent distributors in the chain of distribution 611. The remainder is multiplied by the distributor ratio (0.5), and then compared to the minimum disbursement amount, $0.001. If the product of the remainder and the distributor ratio is less than the minimum disbursement amount, the remainder is paid to the distributor, in this case the primary purchaser 0302 612. If the product of the remainder and the distributor ratio is greater than the minimum disbursement amount, another calculation must be made in order to determine the distribution of the remainder of the net proceeds. The remainder is now multiplied by (1—distributor ratio) 614. If this product is less than the minimum disbursement, the system pays the remainder to the distributor, in this case primary purchaser 0302 612. If this product is greater than the minimum disbursement amount, the system then calculates the distributor disbursement amount for primary purchaser 0302, by multiplying the remainder by the distributor ratio 615. This distributor disbursement amount is paid to the primary purchaser 0302, and subtracted from the remainder 616. When the distributor disbursement amount is subtracted from the remainder, a new remainder is created 617. The distribution table 501 is referenced to determine the next previous distributor at Level N-1. In this situation the next distributor of the digital content is the owner 0122 at Level 0 618, 606.

The system then determines how to distribute the new remainder through the same process described above. In this example, the system references the file table 206 to find the owner of the digital content, and determines that it is owner 0122 607. Since the distributor at this level, Level 0, is the same as the content owner 608, the remainder is paid to the content owner 609, and no further disbursements of the revenue from this transaction are necessary 610.

This method of determining the distribution of proceeds can go on for an indefinite number of iterations. The tertiary distributor may distribute the content to a quaternary distributor, and that distributor on to a quinary distributor and so on. No matter how many distributors the content is delivered to, the owner 0122 will always receive the specified owner revenue. The distributor next up the chain of distribution will receive the remainder multiplied by the distributor ratio. This method will cause the remainder to diminish as the revenue is further distributed up the chain towards the owner. If the owner is reached before the remainder or the distributor disbursement amount becomes too small, before they become less than the minimum disbursement amount, then both amounts will be paid to that distributor in the chain, and the previous distributors, other than the owner, will collect no revenue from that particular transaction.

What is claimed is:

1. A method of distributing digital files over a network, comprising a network server, a processor, a memory and computer software, said software being located in said memory and run by said processor, said computer software comprising an algorithm, wherein said algorithm comprises the steps:
a. Selecting a price at which to sell a digital file;
b. Uploading the digital file to the memory;
c. Selling the digital file from a content provider to at least one purchaser;
d. Allowing the at least one purchaser to sell the digital file to other purchasers;
e. Allowing all purchasers of the digital file to sell the digital file to other purchasers;
f. Creating a chain of sellers of the digital file, the chain comprising the seller of the digital file to the most recent purchaser, and all previous sellers of the digital file back to the content provider; and
g. From each sale of the digital file, disbursing the revenue among the content provider and all sellers in the chain of sellers;

2. The method as in claim 1, further comprising selecting a fixed percentage of the revenue from each sale of the digital file, and disbursing that fixed percentage to the content provider;

3. The method as in claim 2, further comprising calculating a remainder to be the amount of revenue from each sale minus the fixed percentage disbursed to the content provider, and disbursing the remainder from each sale of the digital file among the content provider and all sellers in the chain of sellers;

4. The method as in claim 3, further comprising disbursing a portion of the remainder to the current seller of the digital file, and all previous sellers in the chain of sellers, such that the portion of the remainder that is disbursed to a seller is larger than the portion of the remainder disbursed to the previous seller in the chain of sellers;

5. The method as in claim 4, further comprising calculating the amount of the remainder to disburse to each seller in the chain of sellers, comprising the steps of;
a. Selecting a disbursement ratio;
b. Calculating a disbursement amount by multiplying the disbursement ratio by the remainder;
c. Disbursing the disbursement amount to the current seller of the digital file;
d. Recalculating the remainder by subtracting the disbursement amount from the remainder;
e. Calculating the next disbursement amount by multiplying the disbursement ratio by the remainder;
f. Disbursing this amount to the previous seller in the chain of sellers;
g. Continuing the recalculation of the remainder and disbursement amounts, and disbursing smaller disbursement amounts to each seller in the chain of sellers back to the seller who purchased the digital file from the content provider; and
h. When the previous seller is the content provider, disbursing the remainder to the content provider;

6. The method as in claim 5, further comprising a limit to the disbursements of the remainder, comprising the steps of;
a. Establishing a minimum disbursement amount;
b. If the disbursement amount is less than the minimum disbursement amount, disbursing the disbursement amount and the remainder to the seller in the chain of sellers that received the last disbursement amount; and
c. If the remainder becomes less than the minimum disbursement amount, disbursing the remainder to the seller in the chain of sellers that received the last disbursement amount.
